(19) United States
(12) Patent Application Publication
(10) Pub. No.: US 2025/0246379 A1
(43) Pub. Date: Jul. 31, 2025

(54) METHOD OF MANUFACTURING FLOAT SWITCH

(71) Applicant: Alderon Industries, LLC, Hawley, MN (US)

(72) Inventor: Alexander Richard Guetter, Detroit Lakes, MN (US)

(21) Appl. No.: 18/933,719

(22) Filed: Oct. 31, 2024

Related U.S. Application Data
(60) Provisional application No. 63/625,419, filed on Jan. 26, 2024.

(51) Int. Cl. H01H 11/00; H01H 9/04; H01H 35/18

(52) U.S. Cl. CPC H01H 11/00; H01H 9/04; H01H 35/186

(57) ABSTRACT

A method of manufacturing a float switch assembly for use in actuating a switch to operate a pump to control the level of a fluid in a tank. A method of manufacturing a float switch may include placing two halves of a float switch housing such that contact is made along a relatively flat surface area of the two halves, and moving the two halves in a vibratory manner relative to each other in a direction generally parallel to the relatively flat surface area.

### CROSS-REFERENCE TO RELATED APPLICATIONS

This application claims the benefit under 35 U.S.C. 119 (e) to U.S. Provisional Application Ser. No. 63/625,419, filed Jan. 26, 2024, and titled “Method of Manufacturing Float Switch,” which is hereby incorporated herein by reference in its entirety.

### TECHNICAL FIELD

The present disclosure relates to float switches and float switch assemblies that can be used, for example, to actuate a switch to operate a pump. More particularly, embodiments described herein relate to methods of manufacturing such float switches and float switch assemblies.

### BACKGROUND

Float switches have been used to control the operation of pumps associated with fluid in a tank. As examples, a fluid pump may be turned on to pump fluid out of a tank in response to a float switch rising in the tank to a level that indicates a high level of fluid in the tank, and/or the pump may subsequently be turned off in response to the float switch moving lower in the tank to a level that indicates a low level of fluid in the tank.

Manufacturing a float switch can be difficult due to performance and operational constraints of typical float switches. For example, the float switch typically includes both electrical components and movable mechanical components that operate to open and/or close a switch in an electrical circuit (e.g., to control the starting and/or stopping of an associated pump). At the same time, the float switch typically operates in a fluid environment that requires the electrical components and movable mechanical components to be protected from the surrounding fluid environment (e.g., an internal volume of the float switch housing the electrical and mechanical components is desirably fluid-tight, or at least fluid resistant, in order to function properly). It has become increasingly desirable to improve the efficiency and/or speed of manufacturing float switches without damaging or weakening any of the components thereof in the process. Accordingly, there is a need for improved methods of manufacturing float switches.

### SUMMARY

A method of manufacturing a float switch (e.g., a float switch as part of a system for controlling a pump to vary a level of a fluid in a tank) is herein described. In some embodiments, the method of manufacturing the float switch comprises positioning first and second float switch housing portions in contact with each other and moving one of the first and second float switch housing portions relative to the other in a vibratory manner in a direction generally parallel to the surface plane.

In some embodiments, a method of manufacturing a float switch includes positioning a first housing portion of the float switch in a first mount of a vibration welding apparatus. The first housing portion may have a first internal volume and a first sealing surface, such that the first sealing surface forms a first path disposed generally along a periphery of the first internal volume. The method further includes positioning a second housing portion of the float switch in a second mount of the vibration welding apparatus. The second housing portion may have a second internal volume and a second sealing surface, such that the second sealing surface forms a second path disposed generally along a periphery of the second internal volume. The method further includes positioning at least one electrical component and at least one mechanical component within either (or both) of the first internal volume and the second internal volume. The method further includes positioning the first mount and the second mount in proximity to each other such that the first sealing surface and the second sealing surface are in contact with each other and generally aligned along a surface plane. The method further includes moving the first mount and the second mount relative to each other in a vibratory manner in a direction that is generally parallel to the surface plane to generate heat to form a bond between the first sealing surface and the second sealing surface. In some cases, one of the first and second mounts is held stationary while the other is moved in a vibratory manner.

Although certain embodiments have been herein described, it is contemplated that other embodiments and/or modifications may be made without departing from the concepts captured by the disclosed embodiments. The foregoing description is intended to be illustrative of certain embodiments and not limiting, and the scope of the disclosure shall be determined by reference to the claims.

### BRIEF DESCRIPTION OF DRAWINGS

FIGS. 1A and 1B are schematic side views of a float switch system for operating a pump to control the level of a fluid in a tank, according to some embodiments;

FIG. 2A is a perspective view of a float switch and a tether for use in the system of FIGS. 1A and 1B for operating a pump to control the level of a fluid in a tank, according to some embodiments;

FIG. 2B is a side cross-sectional view of an exemplary float switch showing an arrangement of electrical components and mechanical components disposed within a housing of the float switch, according to some embodiments;

FIG. 3 is a flow diagram showing a number of exemplary steps of a method of manufacturing a float switch, according to some embodiments;

FIG. 4A is a cross-sectional perspective view of an upper housing portion and a lower housing portion of a float switch positioned relative to each other during a method of manufacturing the float switch, according to some embodiments;

FIG. 4B is a cross-sectional top view of an upper housing portion and a lower housing portion of a float switch positioned relative to each other during a method of manufacturing the float switch, according to some embodiments;

FIG. 5 is a cross-sectional top view of float switch housing showing an arrangement of electrical components and mechanical components disposed within a housing of the float switch, according to some embodiments;

FIG. 6A is a partial, cross-sectional perspective view of a float switch housing showing an arrangement that provides for routing of electrical energy and/or signals into and out of the float switch housing, according to some embodiments;

FIG. 6B is a partial, cross-sectional top view of a float switch housing showing an arrangement that provides for routing of electrical energy and/or signals into and out of the float switch housing, according to some embodiments;

FIG. 6C is a partial, cross-sectional end view of a float switch housing showing an arrangement that provides for routing of electrical energy and/or signals into and out of the float switch housing, according to some embodiments;

FIG. 6D includes a number of schematic views of exemplary wire guides that may be employed with the embodiments described in FIGS. 6A-6C;

FIG. 7A is a top perspective view of an exemplary ridge-less float switch housing formed according to some embodiments; and

FIG. 7B is partial end view of an exemplary ridge-less float switch housing formed according to some embodiments.

### DETAILED DESCRIPTION

Reference is made to U.S. application Ser. No. 18/309,346, filed Apr. 28, 2023, entitled “Spring Actuated Float Switch,” which published as U.S. Pub. No. 2023/0352256, the contents of which are incorporated by reference herein in its entirety.

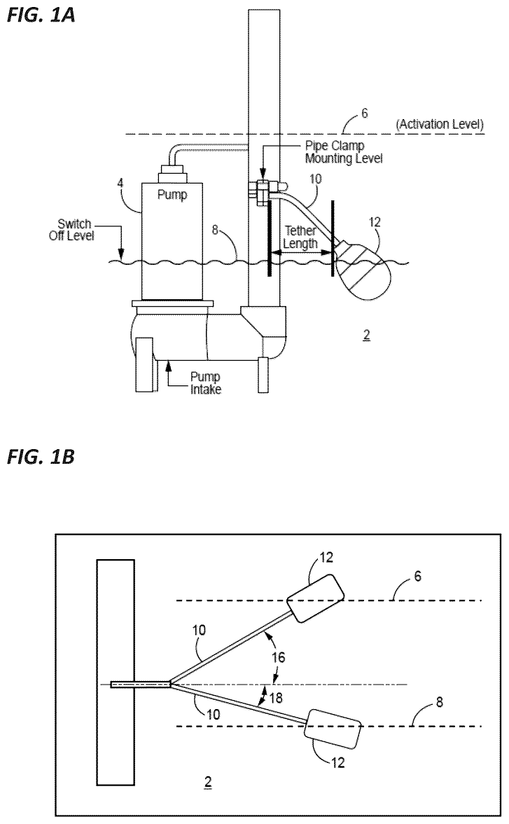

FIG. 1A shows an example of an environment in which an exemplary float switch manufactured according to some embodiments of this disclosure may be employed. In the example depicted in FIG. 1, fluid tank 2 has an associated pump 4 that can be selectively actuated or operated to pump fluid out of the tank 2 to reduce the level of the fluid in the tank 2 from a high level 6 (“Activation Level”) down to a low level 8 (“Switch Off Level”), at which point the pump 4 is turned off and remains off until the fluid level in tank 2 again rises and reaches the high level 6. A float switch 12 is configured to float at or near the level of the surface of the fluid in the tank 2, and float switch 12 is further configured to move up and down with changes in the fluid level in the tank 2. That is, the float switch 12 is buoyant relative to the fluid in tank 2, or the float switch is less dense than the fluid held in the tank 2. In some embodiments, a tether 10 may be coupled to the float switch 12 at a distal end of the tether 10, and the proximal end of the tether 10 may be operably and/or pivotably coupled at a substantially fixed level or height in the tank 2, such that the tether 10 and the float switch 12 are configured to be disposed at an angle with respect to the surface of the fluid in the tank 2, and such that the angle will vary with changes in the fluid level in the tank 2. In some cases, the tether 10 may include a somewhat rigid exterior to help the tether 10 and float switch 12 form an angle. For example, the angle formed by the float switch 12 and tether 10 with respect to the level of the fluid in the tank 2 generally corresponds to a certain level of fluid in the tank 2. In a typical configuration, the angle formed by the float switch 12 and tether 10 will be an “up-angle” when the fluid level in the tank 2 is at the high level 6 (or activation level 6), and the angle formed by the float switch 12 and tether 10 will be a “down-angle” when the fluid level in the tank 2 is at the low level 8 (or switch off level 8).

FIG. 1B illustrates a high level angle 16 that may correspond to the fluid level in the tank 2 being at the high level 6 setpoint, for example. FIG. 1B also illustrates a low level angle 18 that may correspond to the fluid level being at a low level 8 setpoint, for example. As illustrated in the example shown in FIG. 1B, high level angle 16 is an up-angle (e.g., a positive angle or upward angle), and low level angle 18 is a down-angle (e.g., a negative angle or downward angle), but other combinations and/or possibilities could exist. For example, both angles could be positive (upward), or both could be negative (downward), and they need not be of the same magnitude. This might be accomplished, for example, by forming an upward or downward bend in the tether 10 so that the angle of the body or housing of the float switch 12 is not necessarily the same as the angle of the tether 10 with respect to horizontal.

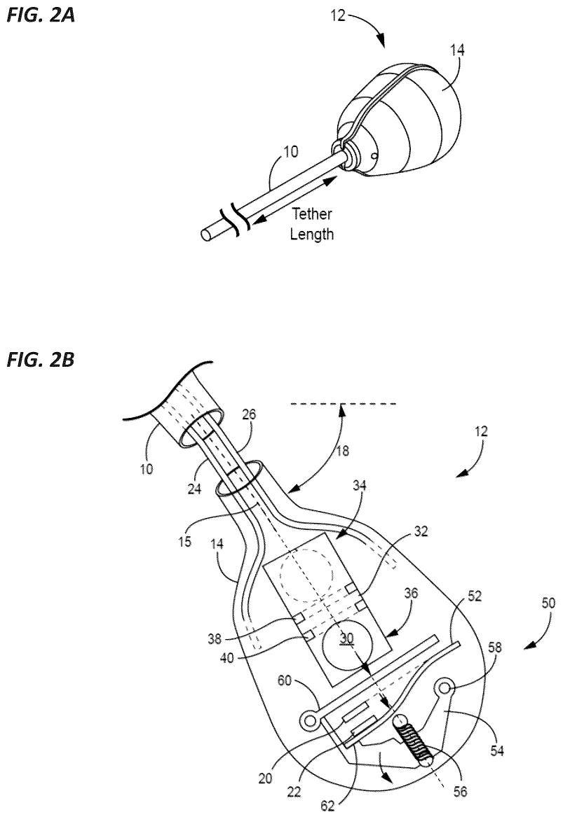

FIG. 2A illustrates a tether 10, the distal end of which is coupled to an exemplary float switch 12 at a proximal portion of a float switch housing 14. Tether 10 may be elongate, such as an elongate cylindrical shape, having a proximal end and a distal end. A proximal end of the tether 10 is shown extending proximally (e.g., to the left, as depicted in FIG. 2A) from the float switch housing 14 along a generally straight portion of the tether 10, although as noted above, the tether 10 need not be straight and may include a bend or a curve to vary the operating characteristics of the float switch 12. In some embodiments, the tether 10 may house electrical wires or cables for supplying power and/or control signals to the pump 4. In some embodiments, the tether 10 may comprise a relatively rigid portion of an otherwise flexible cable. In some embodiments, tether 10 may comprise a relatively rigid external portion that houses one or more electrical cables therein; in such an embodiment, tether 10 may provide a fluid-tight environment for such electrical cables housed therein.

FIG. 2B is a side cross-sectional view of an exemplary float switch 12 as it might appear when disposed at or near a low level setpoint in a fluid tank, for example, angled downwardly at an angle 18 as shown in FIG. 2B. Float switch 12 comprises a housing 14 that forms an outer shell and an inner volume, and which may form a generally annular shape. In the particular example shown in FIG. 2B, housing 14 is generally bulb-shaped or ball-shaped, but other possibilities exist, and housing 14 need not be symmetrical in shape. Housing 14 may, for example, extend generally along an axis 15 from a proximal end (upper left portion in FIG. 2B) to a distal end (lower right portion in FIG. 2B) of the housing 14. Housing 14 is generally hollow in construction (e.g., to provide buoyancy to the float switch 12) and is configured to house a number of switch components (e.g., electrical and mechanical components) therewithin. Housing 14 may be formed of a lightweight material (e.g., a plastic or similar) such that it will be buoyant in the fluid environment in which it is intended to operate. That is, float switch 12 (including housing 14 and components housed therewithin) is generally configured to float at or near a surface level of the fluid in the fluid tank, and to move upward and downward in response to changes in the level of the fluid in the tank.

Housing 14 may be formed of multiple pieces fit or fastened together, e.g., two halves that are fastened together. An example of a suitable plastic material for forming housing 14 includes polypropylene, although many similar suitable alternative materials may be used as well. In the exemplary methods of manufacturing a float switch 12 described herein, housing 14 is described as being formed of two halves, for example an upper half and a lower half, or a right half and a left half. However, it should be noted that other possibilities are contemplated, and the techniques and methods described herein could be applied to float switch housings formed of more than two pieces, or to float switch housings where a first portion and a second portion are not of the same size or proportion relative to the overall size of the housing 14, for example. A description of various exemplary electrical components and mechanical components that may typically reside within housing 14 follows.

FIG. 2B is a cross-sectional view that illustrates a number of electrical and mechanical components that may be housed within an internal volume of an exemplary float switch 12. For example, float switch 12 may have a first electrical contact 20 and a second electrical contact 22 disposed within housing 14, the first and second electrical contacts 20 and 22 being configured to move with respect to each other such that they are in one of two positions: (1) a closed position, where the electrical contacts 20 and 22 are in contact with each other to complete an electrical circuit, or (2) an open position, where the electrical contacts 20 and 22 are physically separated from each other to interrupt or break the electrical circuit path. When electrical contacts 20 and 22 are in the closed position, an electrical circuit within float switch 12 is completed to enable delivery of electrical power to pump 4. When electrical contacts 20 and 22 are in the open position, the electrical circuit within float switch 12 is interrupted to disable or stop delivery of electrical power to pump 4. In the embodiment shown in FIG. 2B, there is shown a stationary electrical contact 20, and a movable electrical contact 22. However, it is contemplated that both electrical contacts could be movable, or that the relative positions of the movable and stationary electrical contacts could be reversed, etc. Electrical power supply lines 24 and 26 are shown entering the housing 14 via an insulated housing, which may be the distal end of tether 10 according to some embodiments. If the electrical contacts 20 and 22 are in the closed position, for example, an electrical circuit may be completed from power supply line 24, which is electrically coupled to contact 20 (not shown), through contact 22, which in turn is electrically coupled to power supply line 26 (not shown), thereby completing the electrical circuit and enabling electrical power to be supplied/delivered to the pump 4. If instead, the electrical contacts 20 and 22 are in the open position (as depicted in FIG. 2B), the electrical circuit would be broken by the gap between the electrical contacts 20 and 22, and electrical power would not be delivered to the pump 4.

An electrical switch assembly may be disposed within housing 14 of float switch 12 and may comprise a ball 30 disposed within a channel 32 formed within housing 14. The channel 32 may be configured to be generally aligned with or generally parallel to the axis 15 of the housing 14. Channel 32 is sized and/or shaped to allow slidable and/or rolling movement of ball 30 within channel 32 along a length of channel 32. Ball 30 may be a spherical ball 30 such that gravity causes rolling and/or sliding movement of ball 30 within channel 32. Channel 32 extends within the housing 14 to thereby enable movement of the ball 30 within the channel 32, for example, from a first position at or near a more distal portion 36 of the channel 32 to a second position at or near a more proximal portion 34 of the channel 32 in response to the angle of the housing 14 reaching and/or exceeding a first threshold angle, for example reaching the high level angle 16 corresponding to the fluid level in the tank 2 being at or above the high level 6 setpoint. High level angle 16 may typically be an upward angle (e.g., where the housing 14 and tether 10 are above the level at which the tether 10 is pivotably coupled within the tank 2), but it need not be an upward angle. Conversely, movement of the ball 30 within the channel 32 may be from the second position at or near the more proximal portion 34 of the channel 32 to the first position at or near the more distal portion 36 of the channel 32 in response to the angle of the housing 14 reaching and/or falling below a second threshold angle, for example reaching the low level angle 18 corresponding to the fluid level in the tank 2 being at or below the low level 8 setpoint. Low level angle 18 may typically be a downward angle (e.g., where the housing 14 and tether 10 are below the level at which the tether 10 is pivotably coupled within the tank 2), but it need not be a downward angle.

In some embodiments, channel 32 may include one or more ball angle barriers to control and/or adjust the angle at which the ball 30 moves from the first position to the second position, or from the second position to the first position. For example, a ball angle barrier, such as angle barriers 38 and/or 40 shown in FIG. 2B, may comprise a portion of the channel 32 with a somewhat restricted path (e.g., the ball angle barriers 38 and 40 may form one or more transversely-oriented “ribs” each having an opening, one or more of the openings having a somewhat reduced inner radius for example) so as to provide a relatively small barrier to the ball 30; the ball angle barriers 38, 40 may thereby function to keep the ball 30 from constantly moving within the channel 32, especially when the fluid level in the tank 2 is such that the angle of the housing 14 is close to horizontal, for example. The ball angle barriers or ribs 38, 40 therefore function so that the angle of the housing 14 relative to the surface level of the fluid in the tank 2 must be greater than a certain threshold angle (either upward or downward) before the ball 30 will overcome (e.g., roll over) the one or more angle barriers 38 and/or 40 and move from one position within the channel 32 to the other. The at least one angle barrier 38, 40 can thereby provide a form of hysteresis in the functioning of the float switch mechanism to avoid unnecessarily frequent switching of the pump 4 off and on when there are relatively small changes in the angle of the housing 14, for example when the housing 14 is nearly horizontal. In some embodiments, it may suffice to have a single angle barrier 38 or 40 positioned between the proximal portion 34 and the distal portion 36 of the channel 32 (e.g., roughly mid-way). In other embodiments, it may be desirable to have two angle barriers 38 and 40 disposed within the channel 32, for example to separately control and/or individually vary the high level angle 16 differently from the low level angle 18. In some embodiments, the one or more angle barriers 38, 40 may comprise one or more angle barrier collars 38, 40 (as depicted in FIG. 2B) that may facilitate making adjustments to the high level and/or low level angles 16 and 18 respectively, for example. This could be accomplished, for example, by placement of one or more angle barrier collars 38, 40 with varying inner radii, for example, or by otherwise varying the inner radius of each angle barrier collar 38, 40 such that it forms an adjustable angle barrier collar to enable adjustment of the associated threshold angle. In some embodiments, there can be a plurality of ribs or angle barriers, and they may include a range of varying inner radii so as to form a “ramp” of a desired angle or slope along a series of such ribs, for example.

Angle barrier collars 38, 40 may comprise rings (e.g., plastic rings) having an outer diameter configured to be placed in a slot or channel formed within housing 14, and having an inner diameter configured to effect the desired response, e.g., to vary the associated high level and low level angles 16 and 18. It is contemplated that a plurality of such rings with varying inner diameters could be provided for this purpose. In such an embodiment, for example, housing 14 may be formed from two portions (e.g., two halves) to facilitate placement of the one or more angle barrier collars 38, 40 within housing 14 (e.g., during manufacturing).

An exemplary biasing mechanism 50 is also depicted in FIG. 2B. Biasing mechanism 50 may be disposed within housing 14 and may include one or more of the associated elements shown in FIG. 2B in various combinations and configurations. Biasing mechanism 50 may be configured to bias or urge the first and second electrical contacts 20, 22 toward either the open position or the closed position. In the embodiment depicted, biasing mechanism 50 may comprise a spring element 52 shown with movable contact 22 coupled to a distal portion of spring element 52 to enable movement of contact 22 relative to stationary contact 20. For example, spring element 52 may comprise a flat spring element 52 fixedly coupled within housing 14 at a proximal end of spring element 52, such that the distal end of flat spring 52 (and hence, the movable contact 22 coupled thereto) can move toward and/or away from stationary contact 20. Flat spring 52 may be a conductive element such that electrical current may pass through flat spring 52 when electrical contacts 20 and 22 are in the closed position, for example. Flat spring element 52 may be biased or tensioned to attempt to maintain contact between electrical contacts 20 and 22 (e.g., in the closed position), and may require a force (e.g., the weight of ball 30 acting directly or indirectly on spring element 52) to move the electrical contacts 20 and 22 apart (e.g., to the open position), as is shown in FIG. 2B. Alternatively, it is envisioned that the arrangement could be modified to an alternate arrangement (not shown) such that the flat spring element 52 is biased to urge the electrical contacts 20 and 22 apart (e.g., toward the open position), and where a force would be required (e.g., the weight of ball 30 acting directly or indirectly on spring element 52) to move the electrical contacts 20 and 22 towards each other into physical contact (e.g., toward the closed position). The remaining description will focus on the embodiment depicted in FIG. 2B, while noting that minor modifications could be made by those of ordinary skill to achieve alternate arrangements, as desired.

In the embodiment depicted in FIG. 2B, a second spring element may be used to further bias the electrical contacts 20, 22 toward each other (e.g., toward the closed position). In the embodiment shown, a spring 56 (e.g., a coiled spring 56) is used to bias a pivot arm 54 pivotably coupled within housing 14 at a proximal end about a pivot point 58. Pivot arm 54 may include a notch or slot 62 formed in a distal end of pivot arm 54 to engage and/or bias flat spring 52. For example, spring 56 applies tension to pivot arm 54 to urge pivot arm 54 to rotate in a clockwise direction, which urges flat spring 52 (e.g., via notch/slot 62) to move contact 22 toward the closed position in contact with stationary contact 20 in the embodiment shown.

In the embodiment shown in FIG. 2B, the downward angle of housing 14 in combination with the weight of ball 30 (e.g., due to gravity) is enough to first overcome the ball angle barrier 38 and/or 40, and then sufficient to overcome the bias provided by flat spring 52 and/or spring 56, resulting in the electrical contacts 20 and 22 being moved apart and held in the open position. In some embodiments, a lever 60 may be employed to cause the weight of ball 30 to act upon the pivot arm 54, as shown in FIG. 2B. For example, the weight of ball 30 acting against lever 60 may cause lever 60 to move downward and/or pivot about a pivot point, as shown in FIG. 2B for example, with lever 60 thereby pushing against a distal portion of pivot arm 54, causing pivot arm 54 to pivot in a counter-clockwise direction against the bias of the spring 56 and/or the flat spring 52.

The above-described electrical and mechanical components are exemplary and illustrative only and serve to demonstrate the nature and the desirability of the methods of manufacturing a float switch according to some embodiments of this disclosure.

Disclosed herein is a method of making a float switch via vibration welding. Vibration welding can improve the manufacturing process by forming joints or seals more rapidly than other methods, and it can be done with many materials without creating smoke and/or causing rusting of interior components, for example. However, certain challenges may be presented with vibration welding. For example, the rapid back-and-forth motion used to generate a vibration weld can potentially cause damage to certain elements (such as shearing of pivot pins, for example). Also, sealing around elements that extend outside of the welded housing (e.g., wires or cables that communicate power or signals to and from the housing) can be challenging due to the back-and-forth motion employed with vibration welding.

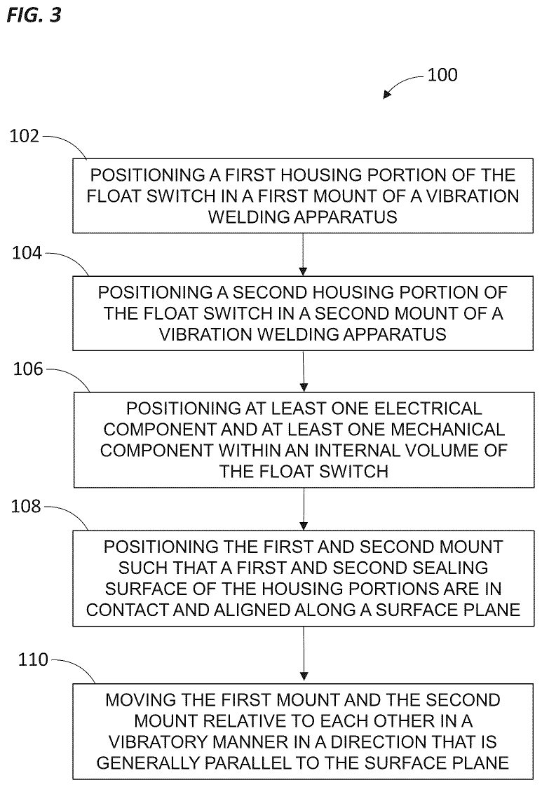

FIG. 3 is a process flow diagram illustrating an exemplary method 100 of manufacturing a float switch according to embodiments of this disclosure. With reference to FIG. 3, a method of manufacturing a float switch may include the following exemplary steps.

In Step 102, the method 100 of manufacturing a float switch may include positioning a first housing portion of the float switch in a first mount of a vibration welding apparatus. The first housing portion may form a first internal volume and a first sealing surface; the first sealing surface forms a first path that is disposed generally along a periphery of the first internal volume. In some cases, the first path may have a relatively flat surface which lies in a plane (e.g., a surface plane).

In Step 104, the method 100 of manufacturing a float switch may include positioning a second housing portion of the float switch in a second mount of a vibration welding apparatus. The second housing portion may form a second internal volume and a second sealing surface; the second sealing surface forms a second path that is disposed generally along a periphery of the second internal volume. In some cases, the second path may have a relatively flat surface which lies in a plane (e.g., a surface plane).

In Step 106, the method 100 of manufacturing a float switch may include positioning at least one electrical component and at least one mechanical component within an internal volume of the float switch. The internal volume of the float switch may include the first internal volume of the first housing portion and the second internal volume of the second housing portion. For example, in some cases, the at least one electrical component and the at least one mechanical component may be positioned (e.g., installed, or placed) within the first internal volume of the first housing portion. Alternatively, the at least one electrical component and the at least one mechanical component may be positioned (e.g., installed, or placed) within the second internal volume of the second housing portion. In other cases, it may be desirable to place certain components in the first internal volume of the first housing portion, and other components in the second internal volume of the second housing portion.

In Step 108, the method 100 of manufacturing a float switch may include positioning the first mount and the second mount such that the first sealing surface of the first housing portion and the second sealing surface of the second housing portion are in contact with each other; in some cases, the first and second sealing surfaces will also be generally aligned along a surface plane formed at the contact between the first and second sealing surfaces.

In Step 110, the method 100 of manufacturing a float switch may include moving the first mount and the second mount relative to each other in a vibratory manner in a direction (e.g., a direction of vibration) that is generally parallel to the surface plane. In some cases, moving the first and second mounts relative to each other in a vibratory manner in a direction of vibration will result in heat being generated between the first sealing surface and the second sealing surface sufficient to form a bond therebetween.

In some embodiments, the method 100 of manufacturing a float switch may further include applying a pressure between the first sealing surface and the second sealing surface in a direction normal to the surface plane. In some cases, the method 100 may comprise applying the pressure between the first sealing surface and the second sealing surface while the first mount and the second mount are being moved relative to each other in a vibratory manner. In some cases, the method 100 may comprise applying the pressure between the first sealing surface and the second sealing surface after the first mount and the second mount are no longer being moved relative to each other in a vibratory manner. In various alternatives, the method 100 may involve applying the pressure between the first and second sealing surfaces (a) only during vibratory motion; (b) only following vibratory motion; or (c) both during and following the application of vibratory motion. In some embodiments, the pressure may be applied between the first and second sealing surfaces for a predetermined period of time after the first and second mounts are no longer being moved relative to each other in a vibratory manner.

In some further embodiments, the pressure may be applied between the first and second sealing surfaces until a measured parameter meets a threshold value. For example, the pressure applied may continue until a measured value of temperature, or strain, or thickness, etc., is reached; empirical data may be used, for example, to determine values of such parameters which may indicate that a sufficient vibration weld has been formed between the first and second sealing surfaces of the first and second housing portions.

In certain embodiments, the first housing portion of the float switch and the second housing portion of the float switch comprise two halves of the float switch. In some embodiments, the first mount of the vibration welding apparatus is selected to be a stationary mount, while the other mount (e.g., the second mount) is configured to move relative to the first mount. In such an embodiment, it may be desirable to position the electrical and mechanical components within the stationary mount (e.g., the first mount in this example) when performing step 106 of the method 100 of manufacturing a float switch.

In some embodiments, at least one of the first and second housing portions may include one or more walls configured to protect at least one of the mechanical components disposed within the internal volume of the float switch housing. In some exemplary embodiments, one or more walls may be disposed adjacent a movable mechanical component such that it protects at least a portion of the movable mechanical component from damage during vibratory motion. In some particular embodiments, a pair of walls may be employed to form a short channel disposed on either side of the movable mechanical component, such that the short channel is oriented generally parallel to the direction of vibration. In some embodiments, one or more of such wall features may extend from a respective housing portion, and in some cases may be configured to extend into the internal volume of the opposite housing portion (e.g., from the first internal volume of the first housing portion into the second internal volume of the second housing portion, or vice versa).

In some embodiments, the one or more walls are configured to protect a pivot arm, or a portion of a pivot arm. For example, a pivot arm (such as pivot arm 54 and/or level 60 used as part of biasing mechanism 50 described above with respect to FIG. 2B) may include a pivot pin configured to be inserted into a hole or recess formed in the first or second housing portions and configured to facilitate rotation of the pivot arm via rotation of the pivot pin within the hole or recess. During the vibratory motion associated with vibration welding, such a pivot pin may be effectively protected from damage (e.g., shearing, breaking) by the placement of one or more walls relative to the pivot arm that allow movement in the direction of vibration, while maintaining a protected region (the “channel” formed between two walls, for example) that help avoid contact with the pivot arm that would place stress on the pivot pin during vibration welding.

In some embodiments, the method 100 of manufacturing a float switch may include forming one or more angled ribs within at least one of the first and second housing portions. In such embodiments, the one or more angled ribs may each comprise a transversely oriented rib with an opening disposed therein, the opening configured to promote movement of an actuator within the float switch. In some examples, a series of angled ribs may include a succession of openings of various sizes to thereby create an internal angle or “ramp” to influence the travel of the actuator as it moves in the channel within the float switch housing. In some cases, the actuator used may be a ball (e.g., a weighted ball) that is configured to move within the channel along a length of the channel in response to the float switch changing from an up-angle to a down-angle, or vice versa. Varying the size of the openings in a series of angled ribs may help achieve a desired motion (and/or acceleration) of the weighted ball to achieve desired operating characteristics, according to some embodiments.

In some embodiments, the method 100 of manufacturing a float switch may further include positioning a neck seal into at least one of the first internal volume and the second internal volume prior to moving the first mount and the second mount relative to each other in a vibratory manner. The neck seal may be disposed in a proximal portion of the float switch and may facilitate coupling to a tether in some embodiments. A neck seal according to this disclosure may include at least one cable guide or channel formed in the neck seal to facilitate passage of an electrical conductor therethrough. In some cases, the neck seal may have one or more of the cable guides/channels formed on one side of the neck seal; in some cases, multiple versions of neck seals may be selected during the manufacturing process to accommodate different numbers of cables, and/or to accommodate different sizes of cables, etc. In embodiments where the cable guides/channels are formed on one side of the neck seal, a flat surface may be formed on a second, opposite side of the neck seal, which may help form part of the sealing surface between the first and second housing portions during vibration welding.

In some embodiments, the method 100 of manufacturing a float switch may include forming a float switch housing from the first housing portion forming a bond with the second housing portion, the bond being formed between the first sealing surface of the first housing portion and the second sealing surface of the second housing portion. The float switch housing formed according to the method 100 is configured to float generally at the level of the surface of the fluid in a fluid tank. The float switch housing formed according to the method 100 may have a generally annular shape, which may include an axis that extends from a proximal end to a distal end of the float switch housing.

The float switch housing formed according to method 100 may include an electrical switch assembly. The electrical switch assembly may be disposed within the float switch housing, and the electrical switch assembly may include a movable actuator (e.g., a ball) disposed in a channel within the float switch housing and configured to move (e.g., roll, slide, etc.) within the channel along the length of the channel. The movable actuator (ball) may be configured to move within the channel from a first position to a second position in response to the angle of the housing reaching a certain angle (e.g., a threshold angle) due to gravitational force acting upon the actuator. The electrical switch assembly may further comprise a first electrical contact and a second electrical contact disposed within the float switch housing. The first and second electrical contacts are configured to move relative to each other between an open position and a closed position, where the closed position forms an electrical connection or contact between the first and second contacts (due to physical contact being made between them in the closed position), which enables delivery of electrical power to the pump. The electrical switch assembly may also include a biasing mechanism disposed within the float switch housing. The biasing mechanism may be configured to bias the first and second electrical contacts toward either the open position or the closed position, in some embodiments. The movable actuator (e.g., the ball) typically has a weight that is sufficient to overcome the bias of the biasing mechanism when the float switch housing is at a sufficient angle, which results in moving the first and second electrical contacts from either the open position to the closed position, or from the closed position to the open position, according to some embodiments.

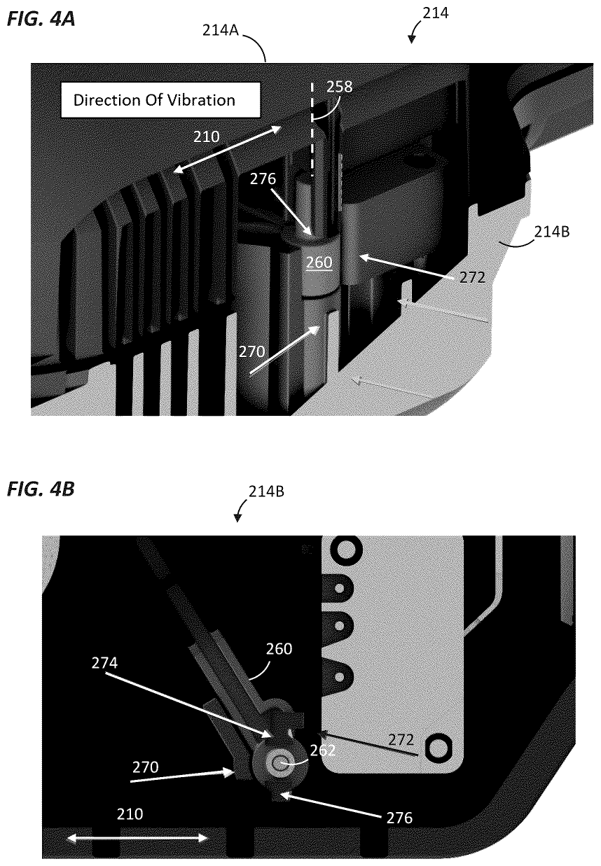

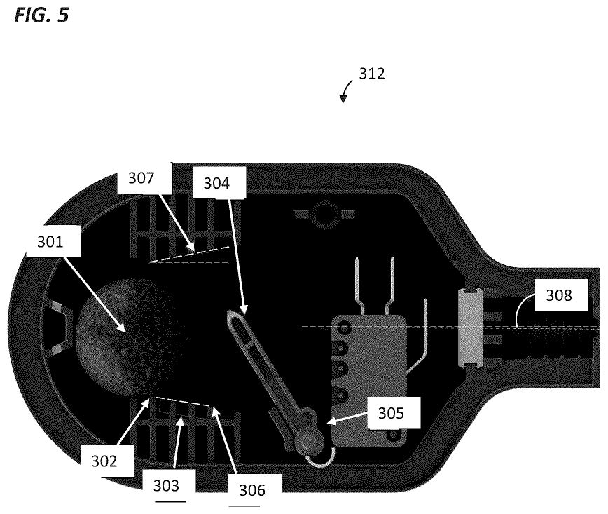

In certain embodiments, a float switch may be formed of two portions, e.g., two halves. The two halves may be formed of suitable materials for bonding together via a vibration welding process, such as certain plastics, e.g., polypropylene, etc. For example, FIG. 4A shows a partial perspective cross-sectional view of a float switch housing 214 that may be formed by bonding two portions (e.g., halves) together to form the float switch housing 214. In the particular example of FIG. 4A, the float switch housing 214 is shown being formed using a stationary bottom half 214B and a moving (or movable) top half 214A as they might be positioned and/or arranged during the vibration welding process. As described above (with reference to method 100 of FIG. 3), once the bottom half 214B is placed (e.g., in a stationary mount of a vibration welding apparatus), the wires and electrical contacts are placed in an internal volume of the bottom half 214B and may be attached or secured to the bottom half 214B. Additionally (e.g., before, during, or after), in conjunction with positioning wires and/or electrical contacts in the internal volume of the bottom half 214B, one or more mechanical components, which may include a movable arm (e.g., pivot arm 260 in FIGS. 4A and 4B) and a movable actuator (e.g., see ball 230 as shown in FIG. 5), are placed inside the float switch housing 214 (e.g., on or in an internal volume of the bottom half 214B). The top half 214A is then positioned over the lower half 214B (with the electrical and mechanical components positioned therein) and welded together (e.g., via vibration welding) to form the float switch housing 214.

### Rotating Arm Support Structure(s)

FIGS. 4A and 4B show an example of a method for securing and/or protecting mechanical components (such as the one or more rotatable arms or pivot arms 260) disposed within the float switch housing 214 during the manufacturing process, while allowing for movement (e.g., rotation) of the mechanical components during subsequent use. The desired movement of pivot arm 260 is a rotational motion about a vertical axis 258, as shown in FIG. 4A. Lateral movement of pivot arm 260 during vibration welding is not desired. A direction of vibration 210 is shown in FIG. 4A, indicating the direction of motion in which the float switch top half 214A will vibrate during vibration welding of the top half 214A to the bottom half 214B. As can be seen, the direction of vibration 210 lies in a plane that is generally transverse to axis of rotation 258. Pivot arm 260 has a pin (pin 262, shown in FIG. 4B) that extends downwardly, generally along axis of rotation 258, and is disposed within a hole formed in the bottom half 214B to facilitate rotational movement of pivot arm 260, for example. This arrangement positions the pivot arm 260 relative to the float switch bottom half 214B and limits or prevents lateral motion of the pivot arm 260. To protect the upper portion of pivot arm 260 (e.g., to prevent torquing of and damage to pivot arm 260), a number of supporting structures may be employed. For example, one side of pivot arm 260 may be protected by a wall 270 protruding from the float switch bottom half 214B (e.g., wall 270 extends upwardly from bottom half 214B, as shown in FIG. 4B). Also shown in FIG. 4B is one side of pivot arm 260 being supported by pressure or force applied from a switching mechanism (e.g., a spring-type mechanism, indicated by arrow 272 in FIG. 4B); in some cases, the force 272 of switching mechanism is toward wall 270 such that pivot arm 260 is securely held therebetween. One or more additional sides of pivot arm 260 may be protected or supported by one or more walls (two walls 274 and 276 are shown in FIG. 4B) protruding or extending downwardly from the float switch top half 214A. These two walls 274, 276 are located in a position and oriented such that, when they are moved in the direction of vibration 210 during vibration welding, they are configured to avoid contact with any portion of pivot arm 260. The positions of walls 274 and 276 is such that they “straddle” a portion of pivot arm 260; walls 274 and 276 are on opposite sides of vertical axis 258 and positioned with respect to each other in a direction generally perpendicular to the direction of vibration 210, as is shown in FIG. 4B. In some embodiments, walls 274 and 276 have a length that is generally aligned with (e.g., generally parallel to) the direction of vibration 210, as is also shown in FIG. 4B. Because they are positioned and/or oriented in this manner, walls 274 and/or 276 can freely move during vibration welding without impacting/damaging the pivot arm 260. Once the vibration welding is done, walls 274 and/or 276 are disposed near an upper portion of pivot arm 260 and may function to prevent torquing thereof. In some embodiments, the wall or walls 274 and/or 276 extending from the top half 214A are configured to permit back-and-forth motion while preventing in-and-out motion, while the wall 270 extending from the bottom half 214B is configured to permit in-and-out motion while preventing back-and-forth motion. A combination of walls 270, 274, and/or 276 may work together to hold the pivot arm 260 in place during the vibration welding process while minimizing the risk of damage to the pivot arm 260.

### Sloping Ramp to Allow for More Actuation Force

Reference is now made to FIG. 5, which is a cross-sectional view of a float switch 312 with various electrical and mechanical components arranged within an internal volume of the float switch 312. The timing of the activation/deactivation of the float switch 312 is determined by the tilting of the float switch 312 to upward and downward angles and the resulting movement of a ball 301 within the float switch 312. In some embodiments, the ball 301 needs to overcome a ridge 302 before rolling along a ramp 303 toward a pivot arm 304, as shown in FIG. 5. For example, when the float switch 312 tilts/rotates in a clockwise direction (e.g., relative to the embodiment as depicted in FIG. 5), there is a point at which the tilt angle enables the ball 301 to overcome and move past the ridge 302. Once past the ridge 302, the ball 301 may roll along the ramp 303 toward the pivot arm 304. As shown, the ramp 303 may be formed of a series of protrusions or “ribs” (e.g., transversely oriented partitions) with openings of varying sizes that together form a sloped contour or ramp to guide and/or urge the ball 301 toward the arm 304. In some embodiments, the ribs or protrusions may be oriented generally transverse to the direction of travel of the ball 301. The ball 301 moves along the ramp 303 (e.g., to the right in FIG. 5) in this manner until it presses against the pivot arm 304, moving the pivot arm 304 to thereby actuate switch 305, e.g., by forming an electrical connection by closing of a pair of contacts, for example. When the float switch 312 subsequently rotates/tilts sufficiently in a counterclockwise direction (e.g., relative to the embodiment as depicted in FIG. 5), the ball 301 will, at some angle of tilt, overcome a ridge 306 and roll away from the switch 305 (e.g., to the left in FIG. 5). Ridge 306 may, for example, be formed as part of one of the protrusions or ribs forming the ramp 303 in some embodiments. This movement of the ball 301 away from the arm 304 will release the force on the arm 304, and thereby deactivate the switch 305. It should be noted that when the ball 301 moves to actuate the switch 305 (e.g., to the right as depicted in the embodiment of FIG. 5), it may also need to overcome an opposing force associate with the switch 305 in order to complete the movement across ridge 306. To facilitate this, the ball 301 may be formed to have a sufficient weight, such that, when used in combination with the ramp 303 being angled sufficiently (see ramp angle 307 in FIG. 5), the force of gravity may enable the ball 301 to overcome the force of the switch 305, which may be a spring force in some embodiments.

Some embodiments may employ narrow angle switch characteristics. For example, a narrow angle switch characteristics may employ a relatively small or narrow angle for both the activation and deactivation of the float switch 312, and in some cases, the two angles may be configured to be equal angles. In some embodiments, this may correspond to the high level angle 16 (with reference to FIG. 1B) and the low level angle 18 (with reference to FIG. 1B) being equal (or nearly equal) to each other.

In some embodiments, a float switch may be manufactured to have a ramp 303 that forms an angle with the centerline 308 of the float switch housing. The float switch may be configured such that the angle to which the switch rotates clockwise (e.g., tilts upward in the embodiment depicted in FIG. 5) above a horizontal orientation to activate the float switch may be determined by the force needed to overcome the switch force (e.g., spring bias of the switch). In subsequent operations, the float switch will deactivate once the switch moves counterclockwise (e.g., tilts downward in the embodiment depicted in FIG. 5) below a horizontal orientation. In some embodiments, it may be desirable to have the deactivation occur at an angle just below the horizontal. This may, in some embodiments, create a pair of unequal activation/deactivation angles (e.g., the magnitude of the high level angle may be greater than the magnitude of the low level angle, for example). Alternatively, the deactivation angle may be configured to be the same as the activation angle.

As noted above, the ramp 303 may form an angle 307 relative to the centerline 308. The angled ramp 303 may facilitate using a smaller activation angle (e.g., it may allow not needing to rotate or tilt the float switch as far in the clockwise direction (with reference to FIG. 5) before moving the ball 301 over the ridge 302, because the ramp angle 307 from gravitational horizontal may be equal to the float centerline angle from gravitational horizontal plus the ramp angle 307 from the float centerline angle. When rotating counterclockwise to deactivate the switch 305, the ramp angle line 307 moves to a level that generally aligns with gravitational horizontal. After the ball 301 overcomes ridge 306, the arm 304 may help propel the ball 301 back across ridge 302, according to some embodiments.

### Wire Entry to Housing Method

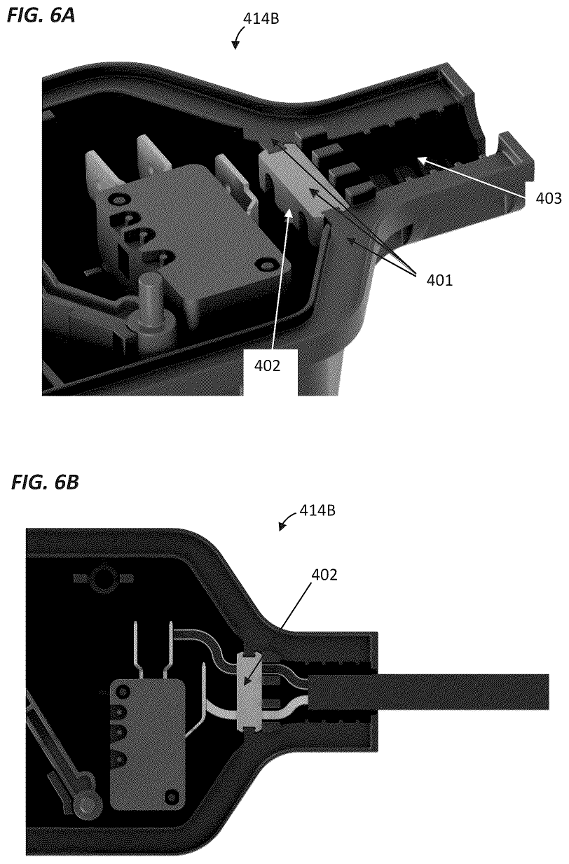

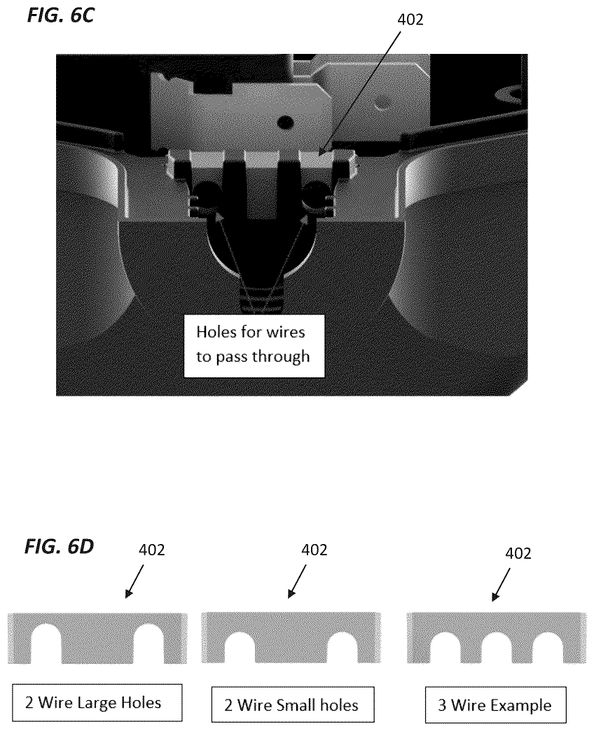

Reference is made to FIGS. 6A and 6B, which show a perspective view and a top plan view, respectively, of a float switch bottom half 414B according to this disclosure. In the exemplary embodiments of this disclosure, a wire cable (or pair of wires or cables) enters the float switch housing 414 through an access point and is connected to the switch mechanism within the float switch housing. Epoxy (or a similar adhesive) may be used to seal the access point around the cable to keep water from entering the housing, for example. The epoxy may also provide a strain relief function for the cable(s) at the access point. The float switch housing may have a neck area 403 where epoxy can be positioned (e.g., applied or poured into) in order to create this seal. To do this, the housing may have a barrier formed around the cable (and/or the conductors of the wire) to keep the epoxy from getting through and/or into the internal volume of the float switch housing. The vibration welding process described above may also benefit from having a flat contact surface (or flat surfaces) near the neck area 403 at which to form such vibration welds. FIGS. 6A and 6B show exemplary flat surfaces 401 positioned to facilitate vibration welding and/or to form a barrier for epoxy. Because there can potentially be different gauges of wire entering the housing, it may be difficult to create a weld joint that can accept all the different possible wire gauge sizes, for example. To overcome this, a wire guide 402 was developed to do any or all of the following: (a) fit around the wires and guide them into the housing; (b) form a barrier to prevent adhesive (e.g., epoxy) from getting into the internal volume of the float switch housing; and/or (c) create a flat surface to facilitate vibration welding. Alternative designs may include the use of two or more wire guides 402 to create the barrier/surface. FIG. 6B shows a tether entering neck area 403, with two wires or cables extending from the tether, through a wire guide 402, and connected to electrical components within internal volume of the float switch housing. FIGS. 6C and 6D show a number of modifications of wire guide 402 for possible use to form the wire guide/barrier/surface. Various designs may have individual wire guides 402 (as shown in FIG. 6C) for sealing around each individual wire, or a single wire guide 402 could be formed to guide multiple wires (e.g., 2 or 3 wires in the examples shown in FIG. 6D; more could be employed as needed). The openings or channels formed in the wire guides 402 may be sized differently (e.g., made available in a number of sizes) to accommodate accepting different numbers (e.g., two or three) of conductor cables, and/or different sizes/gauges of cables.

### Ridge-Less Float

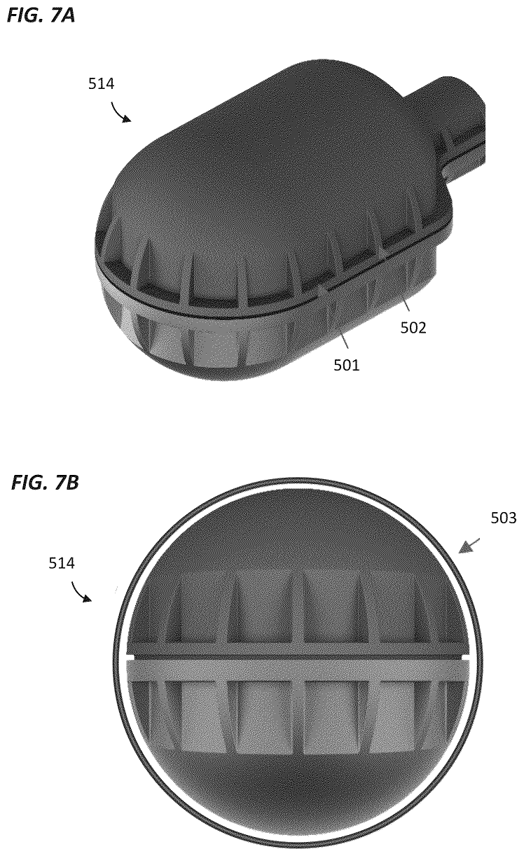

Reference is made to FIGS. 7A and 7B, which show a perspective view and an enlarged side view, respectively, of a “ridge-less” float switch housing 514 of a float switch in accordance with embodiments of this disclosure. In order to use vibration welding to weld plastic parts, a generally flat surface or ridge 501 may be desirable at the weld joint (along adjoining surfaces of both portions or halves of the float switch housing) to facilitate having a consistent force provided along the surfaces to be welded together. At the same time, a “ridge-less” float may be a desirable characteristic for certain floats because the lack of ridges may make the float switch housing less likely to catch on objects while the float switch is in use inside of a tank, for example. To resolve this contradiction in design goals, a float switch housing 514 is disclosed that incorporates a number of contour-following ribs 502 that are configured to follow the overall shape or contour 503 of the outer shape of the float switch housing 514. These contour-following ribs 502 may help prevent the float switch housing 514 from getting caught or snagged on objects in the fluid tank, for example. While many existing designs consist of making an object, then creating a weld joint on the outside of that, the design disclosed herein includes making a generally circular or spherical float, then cutting the weld joint into the float switch housing 514. This may provide the ability to enhance/maintain the buoyancy of the float based off the widest part of the weld joint.

As shown in FIGS. 7A and 7B, the contour-following ribs 502 may be formed in both the upper and lower halves of the float switch housing 514. In some embodiments, a plurality of contour-following ribs 502 are formed and spaced around a periphery of the float switch housing 514. In some embodiments, the contour-following ribs 502 of the upper half of the float switch housing 514 are generally aligned with the contour-following ribs 502 of the lower half of the float switch housing 514. In some embodiments, the plurality of contour-following ribs 502 are formed to be generally perpendicular to the flat surface or ridge 501 that forms the vibration welding surface around the periphery of the float switch housing 514.

Other embodiments and variations will become apparent to those of ordinary skill in the art and are deemed to be within the scope of this disclosure.

What is claimed is:

1. A method of manufacturing a float switch, the method comprising:
positioning a first housing portion of the float switch in a first mount of a vibration welding apparatus, the first housing portion having a first internal volume and a first sealing surface, the first sealing surface forming a first path disposed generally along a periphery of the first internal volume;
positioning a second housing portion of the float switch in a second mount of the vibration welding apparatus, the second housing portion having a second internal volume and a second sealing surface, the second sealing surface forming a second path disposed generally along a periphery of the second internal volume;
positioning at least one electrical component within at least one of the first internal volume and the second internal volume;
positioning at least one mechanical component within at least one of the first internal volume and the second internal volume;
positioning the first mount and the second mount such that the first sealing surface and the second sealing surface are generally aligned and in contact along a surface plane; and
moving the first mount and the second mount relative to each other in a vibratory manner in a direction that is generally parallel to the surface plane to generate heat to form a bond between the first sealing surface and the second sealing surface.

2. The method of claim 1, further comprising:
applying a pressure between the first sealing surface and the second sealing surface in a direction normal to the surface plane.

3. The method of claim 2, wherein applying the pressure between the first sealing surface and the second sealing surface occurs while the first mount and the second mount are being moved relative to each other in a vibratory manner.

4. The method of claim 2, wherein applying the pressure between the first sealing surface and the second sealing surface occurs after the first mount and the second mount are no longer being moved relative to each other in a vibratory manner.

5. The method of claim 4, wherein applying the pressure between the first sealing surface and the second sealing surface continues for a predetermined period of time after the first mount and the second mount are no longer being moved relative to each other in a vibratory manner.

6. The method of claim 4, wherein applying the pressure between the first sealing surface and the second sealing surface continues after the first mount and the second mount are no longer being moved relative to each other in a vibratory manner until a measured parameter exceeds a threshold value.

7. The method of claim 6, wherein the measured parameter is a temperature, a strain, or a thickness.

8. The method of claim 1, wherein the first housing portion of the float switch and the second housing portion of the float switch comprise two halves of the float switch.

9. The method of claim 1, wherein the first mount of the vibration welding apparatus is a stationary mount, and wherein the second mount of the vibration welding apparatus is configured to move relative to the first mount.

10. The method of claim 1, wherein at least one of the first housing portion and the second housing portion comprises one or more walls configured to protect at least one of the mechanical components.

11. The method of claim 1, wherein at least one of the first housing portion and the second housing portion comprises one or more angled ribs, the one or more angled ribs configured to promote movement of an actuator within the float switch.

12. The method of claim 11, wherein the actuator comprises a ball.

13. The method of claim 1, further comprising positioning a neck seal into at least one of the first internal volume and the second internal volume prior to moving the first mount and the second mount relative to each other in a vibratory manner, the neck seal comprising:
at least one channel formed in a first side of the neck seal for allowing passage of an electrical conductor therethrough; and
a flat surface formed on a second side of the neck seal, the second side disposed opposite the first side.

14. The method of claim 1, wherein the bond formed between the first sealing surface of the first housing portion and the second sealing surface of the second housing portion forms a float switch housing, the float switch housing configured to float at a surface of a fluid in a fluid tank, the float switch housing being generally annular along an axis extending from a proximal end to a distal end, the float switch housing having:
an electrical switch assembly disposed within the housing, the electrical switch assembly comprising:
a ball disposed in a channel within the housing, the ball configured to move within the channel from a first position to a second position in response to the angle of the housing reaching a first threshold angle;
first and second electrical contacts disposed within the housing, the first and second electrical contacts configured to move relative to each other between an open position and a closed position, the closed position comprising electrical contact across the first and second contacts to enable delivery of electrical power to a pump; and
a biasing mechanism disposed within the housing, the biasing mechanism configured to bias the first and second electrical contacts toward one of the open position and the closed position,
wherein the ball has a weight sufficient to overcome the bias of the biasing mechanism when in one of the first position and the second position.

15. The method of claim 14, wherein the float switch housing further comprises at least one pivot arm configured to pivot in response to movement of the ball within the channel, the at least one pivot arm having a first pin extending into a first hole formed in the first housing portion, and wherein the second housing portion includes one or more walls configured to protect the at least one pivot arm while moving the first mount and the second mount relative to each other in the vibratory manner.

16. The method of claim 15, wherein the one or more walls are configured to move in the vibratory manner adjacent the first pin without contacting the first pin.

17. The method of claim 15, wherein the one or more walls comprises two walls that extend from the second housing portion, the two walls being configured to be disposed on opposite sides of the at least one pivot arm, the two walls being oriented generally parallel to the direction of motion of the first mount and the second mount relative to each other.
